(19) United States
(12) Patent Application Publication
(10) Pub. No.: US 2022/0222321 A1
(43) Pub. Date: Jul. 14, 2022

(54) TENSOR PROCESSING METHOD AND APPARATUS, ELECTRONIC DEVICE

(71) Applicant: GUANGDONG OPPO MOBILE TELECOMMUNICATIONS CORP., LTD., Dongguan (CN)

(72) Inventors: Ming Chen, Palo Alto, CA (US); Chiuman Ho, Palo Alto, CA (US); Zibo Meng, Palo Alto, CA (US)

(21) Appl. No.: 17/707,590

(22) Filed: Mar. 29, 2022

Related U.S. Application Data
(63) Continuation of application No. PCT/CN2020/118435, filed on Sep. 28, 2020.
(60) Provisional application No. 62/908,918, filed on Oct. 1, 2019.

(51) Int. Cl. G06F 17/16; G06T 1/20

(52) U.S. Cl. CPC G06F 17/16; G06T 1/20

(57) ABSTRACT

A tensor processing method and apparatus, and an electronic device are provided. In the method, a first matrix is determined based on a first tensor, and a first sub-matrix is extracted from the first matrix. The first matrix includes all elements of the first tensor, and the first sub-matrix includes all elements of the first subtensor, and the first subtensor is a subset of the first tensor.

### CROSS-REFERENCE TO RELATED APPLICATION

The present application is a continuation of International Application No. PCT/CN2020/118435, filed on Sep. 28, 2020, which claims priority to U.S. Application No. 62/908,918, filed on Oct. 1, 2019, both of which are hereby incorporated by reference in their entireties.

### TECHNICAL FIELD

The disclosure relates to the field of data processing, and more particularly to a tensor processing method and apparatus, and an electronic device.

### BACKGROUND

Once a matrix is defined, it might be necessary to extract a subset from the matrix, to reshape it or to modify the order of its elements. These operations are referred as “matrix manipulation”. Similarly, as a higher-dimension extension of matrix, tensor manipulation is also in great demand. There are many good and highly integrated libraries developed for vector/matrix manipulation. However less support has been provided for tensors, especially for subtensor extraction (or tensor slicing). Subtensor extraction/tensor slicing is the basis for other subtensor operations like assignment, addition, subtraction, or multiplication etc. When there is a strong need for a subtensor extraction, how can we extract it efficiently? On the central processing unit (CPU) side, libraries like NumPy can deal with subtensor extraction efficiently though intelligent indexing, though on the graphic processing unit (GPU) side, subtensor extraction remains a nontrivial task.

### SUMMARY

The embodiments of the disclosure provide a tensor processing method and apparatus, and an electronic device.

According to a first aspect, the disclosure provides a tensor processing method, which may include determining a first matrix based on a first tensor, and extracting a first sub-matrix from the first matrix. The first matrix includes all elements of the first tensor, and the first sub-matrix includes all elements of the first subtensor, and the first subtensor is a subset of the first tensor.

According to a second aspect, the disclosure provides a tensor processing apparatus, which may include a determination unit and an extraction unit. The determination unit is configured to determine a first matrix based on a first tensor, wherein the first matrix includes all elements of the first tensor. The extraction unit is configured to extract a first sub-matrix from the first matrix, wherein the first sub-matrix includes all elements of the first subtensor, and the first subtensor is a subset of the first tensor.

According to a third aspect, the disclosure provides an electronic device, which may include a memory and a processor. The memory stores a computer program. The processor is adapted to call and execute the computer program in the memory to execute the tensor processing method according to the first aspect.

According to a fourth aspect, the disclosure provides a chip, configured to implement the tensor processing method according to the first aspect. Specifically, the chip may include a processor. The processor is adapted to call and execute one or more computer programs in a memory, to cause a device configured with the chip to execute the tensor processing method according to the first aspect.

According to a fifth aspect, the disclosure provides a non-transitory computer-readable storage medium storing one or more computer programs. The computer programs may cause a processor to execute the tensor processing method according to the first aspect.

According to a sixth aspect, the disclosure provides a computer program product including computer program instructions. The computer program instructions may cause the processor to execute the tensor processing method according to the first aspect.

According to a seventh aspect, the disclosure provides a computer program. The computer program, when executed by a processor, causes the processor to execute the tensor processing method according to the first aspect.

According to the above technical solutions of the disclosure, a subtensor extraction method is provided. A first tensor is taken as a first matrix, a first sub-matrix is extracted from the first matrix, and the first sub-matrix is equivalent to the first subtensor to be extracted, thereby implementing extraction of the first subtensor. The proposed subtensor extraction method can be applied to both CPU and GPU utilizing well-developed Linear algebra libraries for tensor manipulation. The proposed method can make the best use of the GPU computing resources by taking advantage of the existing highly optimized libraries.

### BRIEF DESCRIPTION OF THE DRAWINGS

The accompanying drawings described herein which are incorporated into and form a part of the disclosure are provided for the better understanding of the disclosure, and exemplary embodiments of the disclosure and description thereof serve to illustrate the disclosure but are not to be construed as improper limitations to the disclosure. In the accompanying drawings:

FIG. 1 illustrates a flow chart of a tensor processing method according to an embodiment of the disclosure.

FIG. 2 illustrates a diagram of a four-dimensional tensor according to an example of the disclosure.

FIG. 3 illustrates different matrix views of a same tensor according to an example of the disclosure.

FIG. 4 illustrates schematic views of different data storage order with different layouts for a same tensor according to an example of the disclosure.

FIG. 5 illustrates a block diagram of a tensor processing device according to an embodiment of the disclosure.

FIG. 6 illustrates a block diagram of an electronic device according to an embodiment of the disclosure.

FIG. 7 illustrates a block diagram of a chip according to an embodiment of the disclosure.

### DETAILED DESCRIPTION

The technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

In order to facilitate the understanding of the technical solutions of the disclosure, terms and technologies related to the embodiments of the disclosure are described below.

1) Subtensor extraction: extract a subset of tensor from the primary tensor.

2) Permutation: the act of rearranging the order of a set of elements.

3) Row- and column-major order: row-major order and column-major order are methods for storing multidimensional arrays in linear storage such as random-access memory. For a d-dimensional N₁×N₂×N₃ . . . × N_{d} tensor, in row-major order, the last dimension N_{d} is contiguous in memory, while in col-major order, the first dimension N₁is contiguous in memory. Python, C/C++ are row-major, Eigen and cuBLAS are col-major. The conversion between row-major and col-major matrix is equal to matrix transpose.

4) Data Layout: The data layout determines the memory access pattern and has critical impact on the performance and memory efficiency. The common data layout for images are: NHWC, NCHW, HWCN with N refers the numbers of images in a batch, H refers to the number of pixels in vertical dimension (Height), W refers to the number of pixels in horizontal dimension (Width) and C refers to the Channel.

In some technical solutions, tensor slicing/subtensor extraction in GPUs is not supported in many linear algebra libraries, for example:

1) Customized CUDA kernel: copies a subset of tensor element by element, or/and dimension by dimension.

2) Eigen: extracts a subset of tensor through pointer indexing.

At least the following issues exist in the above technical solutions.

First, the customized CUDA kernel for extracting the subtensor through elementwise copy is usually inefficient and cannot fully utilize GPU computing resources. Second, the existing Basic Linear Algebra libraries (BLAS) either does not support multi-dimensional tensor slicing operation (e.g. cuBLAS/MAGMA) or suffers from low speed (e.g. Eigen). Specifically, as given in the following,

A) cuBLAS/CUTLASS/MAGMA/Taco: no tensor slicing operation supported

B) Eigen:

Support slicing: although the function supports slicing the primary tensor in multi-dimension, it is not as efficient as the method proposed in the present disclosure.

In view of this, the present disclosure proposes subtensor extraction methods which can be applied to both CPU and GPU utilizing well-developed Linear algebra library for tensor manipulation. Linear algebra on the CPU include: BLAS, LAPACK, and GPU analogues includes cuBLAS, CUTLASS, MAGMA. Many optimization efforts have also been incorporated to the widely used BLAS libraries, such as cuBLAS, CUTLASS and MAGMA on GPU platforms. The proposed method can make the best use of the GPU computing resources by taking advantage of the existing highly optimized libraries.

The technical solutions of the embodiments of the disclosure are described in detail below.

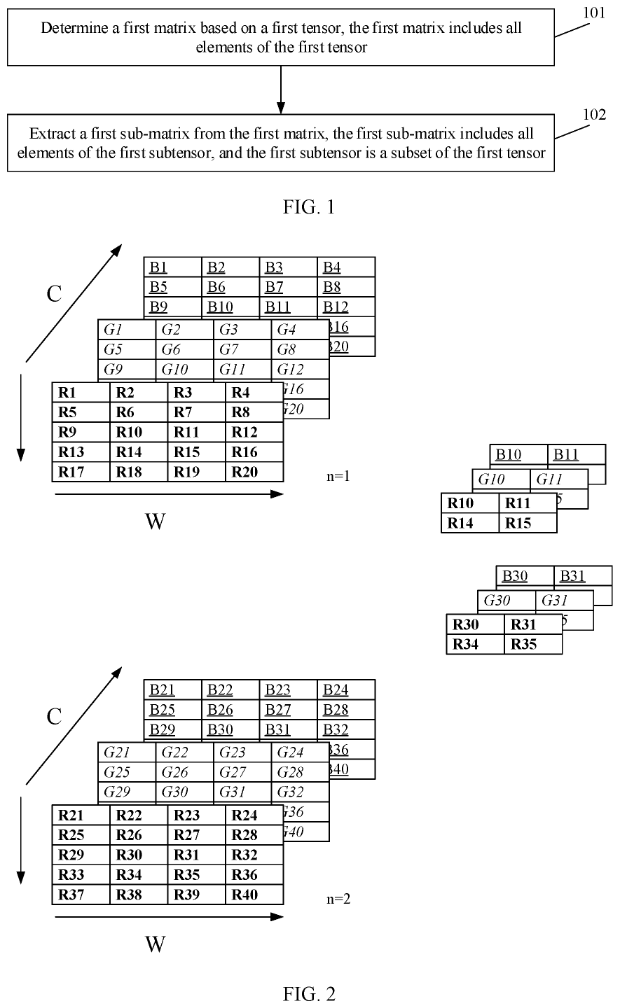

FIG. 1 illustrates a flowchart of a tensor processing method according to an embodiment of the disclosure. Here, the tensor processing method can also be specifically called a subtensor extraction method. As illustrated in FIG. 1, the tensor processing method may include the following operations illustrated in blocks. The method may begin from block 101.

At block 101, a first matrix is determined based on a first tensor. Here, the first matrix includes all elements of the first tensor.

In this embodiment of the disclosure, the first tensor may be any tensor, and the dimension of the tensor is not limited in the disclosure. Generally, the dimension of the first tensor may be greater than or equal to 3. Typically, the first tensor may be a four-dimensional tensor.

Alternatively, the first tensor may be called a primary tensor. The embodiment is intended to extract a first subtensor from the first tensor, and the first subtensor is a subset of the first tensor.

In an implementation of the embodiment, the first tensor may have different layouts. In default, the first tensor may have a first layout, a permutation operation may be performed on the first tensor having the first layout, to obtain the first tensor having a second layout. The first matrix may be determined based on the first tensor having the second layout.

In an example, in a case that the first tensor is a four-dimensional tensor, the first tensor has a shape of N×C×H×W, where each of N, C, H, and W represents a respective one of four dimensions of the first tensor, and the first layout of the first tensor is NCHW, and the second layout of the first tensor is WHCN.

In view of this, the first tensor having the layout of WHCN is taken as a matrix having a shape of W×HCN, where W represents a first dimension of the first matrix, and HCN represents a second dimension of the first matrix.

At block 102, a first sub-matrix is extracted from the first matrix, where the first sub-matrix includes all elements of the first subtensor, and the first subtensor is a subset of the first tensor.

In the embodiment, the first tensor is represented by F, the first subtensor is represented by Fs, and the first tensor and the first subtensor satisfy the following equation:

Fs=F[0:N−1,0: C−1, hs: he, ws: we],

where expression 0:N−1 represents coordinates of a first element to a last element to be extracted in dimension N respectively; expression 0:C−1 represents coordinates of a first element to a last element to be extracted in dimension C respectively; expression hs: he represents a first element to a last element to be extracted in dimension H respectively; and expression ws: we represents a first element to a last element to be extracted in dimension W respectively.

It is to be noted that the equation Fs=F[0:N −1,0:C−1, hs: he, ws: we] may also be briefly written as Fs=F[: , : , hs: he, ws: we] with F and Fs of first layout NCHW.

Before making best use of existing BLAS libraries, either a permutation operation for the first tensor F from first layout NCHW to second layout WHCN on CPU or a data transfer operation from CPU to GPU is needed. Given the fact that the data layout on GPU is column-major, a tensor F of layout NCHW stored on CPU, is equivalent to a tensor F* of layout WHCN stored on GPU, thus a permutation operation is waived. After the permutation or its equivalent operation, the first tensor F of second layout WHCN is denoted as F*, and can be viewed as matrix having a shape of W×HCN.

In this case, the operation of extracting the first sub-matrix from the first matrix may include extracting the first sub-matrix from the first matrix according to the following equation:

Fs*=F*[ws:we, hs×N×C:he×N×C]

where F* represents the first tensor is viewed as the first matrix having a shape of W×HCN, and Fs* represents the first subtensor and is viewed as the first sub-matrix.

It is to be noted that, in the embodiment of the disclosure, the first tensor is not limited to the above described four-dimensional tensor, and the dimensions to be extracted to the two dimensions, i.e., dimension H and dimension W.

The technical solutions proposed in the embodiment of the disclosure can be applied to any existing linear matrix algebra libraries. The technical solutions can generally accelerate linear tensor algebra computing as well as computer vision applications such as image/video cropping or sliding window related tasks.

The technical solutions of the embodiment of the disclosure will be described in conjunction with specific examples. It is to be noted that in the following examples, cuBLAS is used as an example to implement the subtensor-extraction-method in the following context.

Given a 4D tensor of shape N×C×H×W, assume a subtensor to be sliced along H, W dimensions with untouched C, N dimensions. Without losing the generality, assuming the shape of the primary tensor F is N=2, H=5, W=4, C=3 as shown in FIG. 2, the subtensor needs to be extracted can be denoted as Fs=F[:, :, 3:4, 2:3].

It should be noted that when a matrix is passed to CUDA for GPU side operation, the memory layout stays the same. But CUDA assumes that the matrix is laid out in column-major order. This won't cause a buffer overrun, but what it does is effectively transposing the matrix, without actually moving any of the data around in memory—a tensor in the layout of NCHW (row-major) on CPU, will be in the layout of WHCN on GPU.

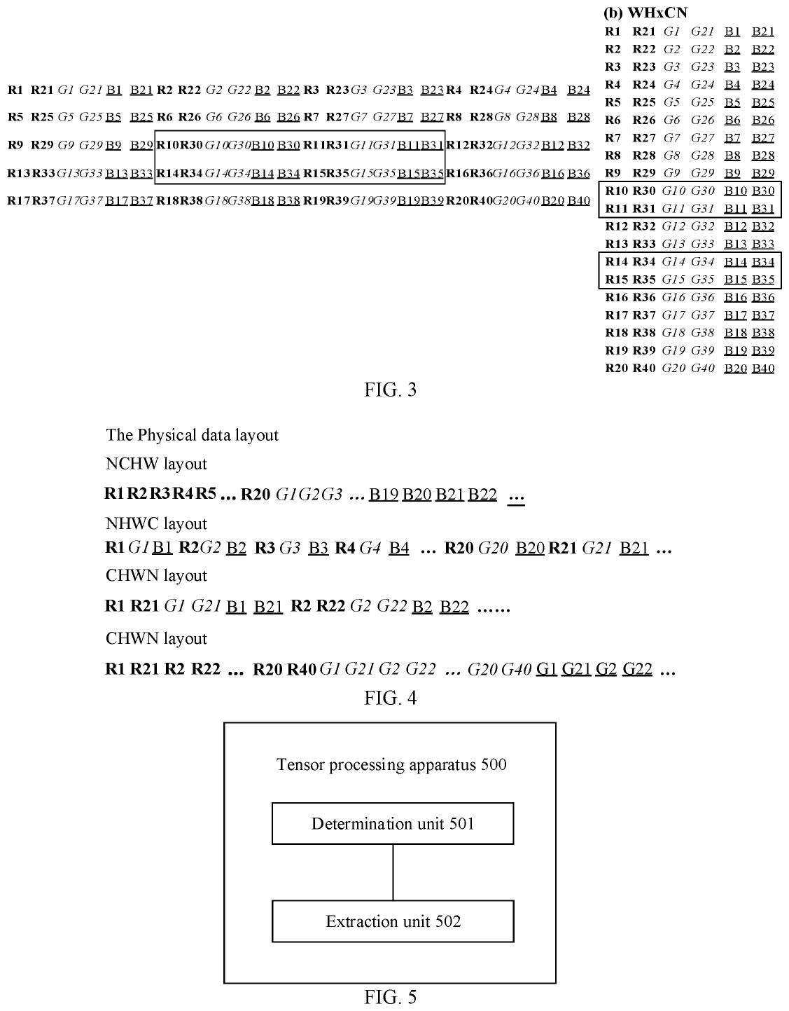

In the present disclosure, three ways are given to view the above-mentioned tensor (on GPU) as matrix−W×HCN, WH×CN and WHC×N. FIG. 3 illustrates W×HCN view and WH×CN view as examples, with the yellow masked region representing the subtensor needed. As illustrated in FIG. 3, under different matrix views, the subtensor may be distributed as one or multiple submatrices. Among the three matrix views, only the W×HCN view results in the least (only one) submatrix extraction—based on this observation, the present disclosure can utilize the optimized GPU performance for subtensor extraction through the application of existing highly optimized libraries on submatrix extraction. Specifically, if need to get Fs=F[: , : , hs: he, ws:we] with F and Fs stored on CPU, F ∈ R^{N×C×H×W}, Fs ∈ R^{N×C×(he-hs+1)×(we-ws+1)}0≤hs≤he<H and 0≤ws≤we≤W it is actually doing Fs*=F*[ws: we, hs: he, : , : ] while F*, Fs* are the corresponding data transferred to GPU (which by default is col-major), it could view F* the as a matrix of shape W×HCN and extract the subtensor efficiently using Fs*=F*[ws: we, hs×N×C: he×N×C] . The following cuBLAS call can be used without developing customized kernel function or suffering from low speed.

cublasSgeam (handle, CUBLAS_OP_T, CUBLAS_OP_N, (we−ws),
(he−hs) ×N×C, 1, d_F*, W, 0, d_Fs*, (we−ws), d_Fs*, (we−ws))

while d_F*, d_Fs*are the pointers to the tensors F* and Fs* on GPU.

Note: cuBLASSgeam is a GEMM API (cublasSgeam) in cuBLAS. cublasSgeam is designed to compute C=αA+βB, for here, Fs*=1×F*[ws: we, hs×N×C: he×N×C]+0×Fs*) is calculated.

It is also to be noted that there are various data layouts for one tensor, and different layouts will lead to different physical storage orders (FIG. 4). To make use of proposed method proposed in the present disclosure, sometimes a permutation might be needed.

Furthermore, this method can be generalized and extended from 3 dimensions (in the previous example, set N=1 or C=1) or 4 dimensions to even higher dimensions. Suppose there is a k-dimensional Tensor F with shape{d₁, d₂, d₃ , . . . , dₖ}, say it is going to take a subtensor with slice in two dimensions dₙand dₘ and full coverage in all other dimensions:

Fs=F[0:d₁−1,0:d₂−1, . . . dₙᵢ:dₙⱼ, 0:dₙ₊₁−1, . . . dₘᵢ:dₘⱼ, . . . 0:dₖ−1]

While 0<dₙᵢ<dₙⱼ<dₙ−1;

0<dₘᵢ<dₘⱼ<dₘ−1;

If F can be permuted to F* as {dₙ, d_{S11}, d_{S12}, . . . , d_{S1P}, dₘ, d_{S21}, d_{S22}, . . . , d_{S2Q}}

While

d_{S1p} ∈ D_{S1}, d_{S2q} ∈ D_{S2},

D_{S1} ∪ D_{S2} ∪{dₙ, dₘ}={d₁, d₂, d₃, . . . dₖ},

D_{S1} ∩ D_{S2}=Ø, D_{S2} ∩{dₙ, dₘ}=Ø, and D_{S2} ∩{dₙ, dₘ}=Ø

Then with the proposed method can view the F* as a matrix of shape

$${F}^{*} [ {d}_{n} \times {\prod }_{{d}_{S 1 p} ∈ {D}_{S 1}} {d}_{S 1 p} , {d}_{m} \times {\prod }_{{d}_{S 2 q} ∈ {D}_{S 2}} {d}_{S 2 q} ] , \\ {\prod }_{{d}_{S 1 p} ∈ {D}_{S 1}} {d}_{S 1 p} = {d}_{S 11} \times {d}_{S 12} \times . . . \times {d}_{S 1 P} , \\ {\prod }_{{d}_{S 2 q} ∈ {D}_{S 2}} {d}_{S 2 q} = {d}_{S 21} \times {d}_{S 22} \times . . . \times {d}_{S 2 Q}$$

and use the conventional routine to take the submatrix of

$${F}_{s}^{*} = {F}^{*} [ {d}_{n i} \times {\prod }_{{d}_{S 1 p} ∈ {D}_{S 1}} {d}_{S 1 p} : {d}_{nj} \times {\prod }_{{d}_{S 1 p} ∈ {D}_{S 1}} {d}_{S 1 p} , {d}_{m i} \times {\prod }_{{d}_{S 2 q} ∈ {D}_{S 2}} {d}_{S 2 q} : {d}_{mj} \times {\prod }_{{d}_{S 2 q} ∈ {D}_{S 2}} {d}_{S 2 q} ] ,$$

So far, in the tensor processing methods according to the embodiment of the disclosure, we have only discussed extracting a subtensor with slice in two dimensions from the primary tensor. Actually, this method can also be applied to multidimensional subtensor extraction. In an extreme case, if one wants to extract a subset of the primary tensor in every dimension.

Fs=F[d₁ᵢ:d₁ⱼ, d₂ᵢ:d₂ⱼ, . . . dₙᵢ:dₙⱼ, . . . dₘᵢ:dₘⱼ, . . . dₖᵢ:dₖⱼ]

while 0<dᵣᵢ<dᵣⱼ<dᵣ−1 for r=0,1,2 . . . k

With the methods proposed in the present disclosure, at most

$$⌈ \frac{{d}_{k}}{2} ⌉$$

times submatrix extraction are performed to get the final result, though some temporary memory buffer may be needed: first of all, extract the submatrix of the last two dimensions, then extract the third and fourth last dimensions, and so on, and lastly process towards the first two dimensions.

According to the methods proposed in the present disclosure, benchmark testing results show that: when extracting a Fs=F[:, : ,1: 399,1: 399]. F ∈ R^{1×512×400×400}, Fs ∈ R^{1×513×398×398}, the method proposed in the present disclosure with cuBLAS call is 1.6 times faster than the Eigen method, and 10 times faster than the elementwise customized kernel function on GPU. Further, the proposed method is of even greater advantage if the continuous dimension (which is C, N in the above-mentioned example) is large.

The methods proposed in the present disclosure can compute linear Tensor Algebra efficiently through applying the proposed subtensor extraction via matrix-specific library methods without developing customized kernel function or suffer from slow speed.

The embodiments of the disclosure also provide a tensor processing apparatus 500, to implement the above-mentioned tensor processing method. As illustrated in FIG. 5, the tensor processing apparatus 500 may include a determination unit 501 and an extracting unit 502.

The determination unit 501 is configured to determine a first matrix based on a first tensor. The first matrix includes all elements of the first tensor; and

The extraction unit 502 is configured to extract a first sub-matrix from the first matrix. The first sub-matrix includes all elements of the first subtensor, and the first subtensor is a subset of the first tensor.

In at least one implementation, the apparatus may further include a permutation unit (not illustrated in FIG. 5), configured to perform a permutation operation on the first tensor having a first layout to obtain the first tensor having a second layout.

The determination unit may be configured to determine the first matrix based on the first tensor having the second layout.

In at least one implementation, in a case that the first tensor is a four-dimensional tensor, the first tensor has a shape of N×C×H×W, wherein each of N, C, H, and W represents a respective one of four dimensions of the first tensor.

Here, the first layout of the first tensor refers to a layout of NCHW, and the second layout of the first tensor refers to a layout of WHCN.

In at least one implementation, the determination unit 501 may be configured to take the first tensor having the layout of WHCN as the first matrix having a shape of W×HCN, where W represents a first dimension of the first matrix, and HCN represents a second dimension of the first matrix.

In at least one implementation, the first tensor is represented by F, the first subtensor is represented by Fs, and the first tensor and the first subtensor satisfy the following equation:

Fs=F[0:N−1,0:C−1, hs:he,ws:we],

Where expression 0:N−1 represents coordinates of a first element to a last element to be extracted in dimension N respectively; expression 0:C−1 represents coordinates of a first element to a last element to be extracted in dimension C respectively; expression hs: he represents a first element to a last element to be extracted in dimension H respectively; and expression ws: we represents a first element to a last element to be extracted in dimension W respectively.

A permutation or equivalent operation on first tensor from first layout NCHW to second layout WHCN is performed resulting a first tensor F* and first subtensor Fs* of second layout.

In at least one implementation, the extraction unit is configured to extract the first sub-matrix from the first matrix according to the following equation:

Fs*=F*[ws: we, hs×N×C: he×N×C]

wherein F* represents second layout of the first tensor F and is viewed as the first matrix having a shape of W×HCN, and Fs*represents the second layout of the first subtensor Fs and is viewed as the first sub-matrix.

In at least one implementation, the first tensor is a four-dimensional tensor directed to image data, and the determination unit is configured to take the first tensor having the layout of WHCN as the first matrix having a shape of W×HCN, wherein N represents a number of images in a batch, H represents a number of pixels in a vertical dimension, W represents to a number of pixels in a horizontal dimension, and C represents a number of channels.

In at least one implementation, the permutation operation on the first tensor is performed in a central processing unit (CPU).

In at least one implementation, the determination unit is further configured to transfer data for the first tensor having the second layout to a graphical processing unit (GPU).

In at least one implementation, the extraction unit is configured to extract the first sub-matrix from the first matrix using a linear algebra library based on a GPU platform.

It is to be understood that in the embodiments of the disclosure, the description of the tensor processing apparatus may be understood with reference to the above related description on the tensor processing method.

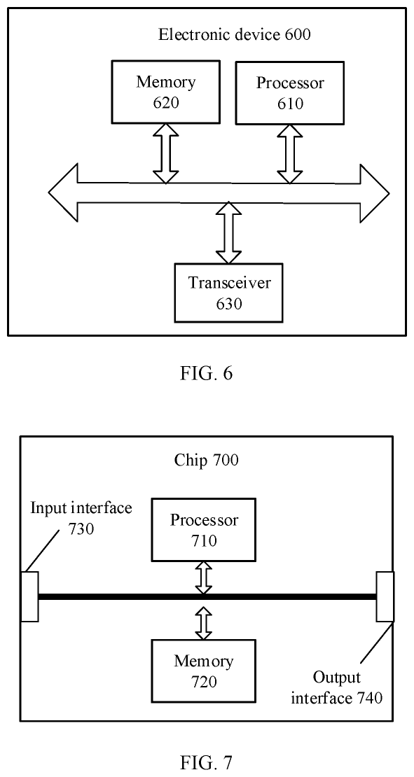

FIG. 6 is a block diagram of an electronic device 600 according to an embodiment of the disclosure. The electronic device may be any device with a computing processing capability such as a terminal or a server. As illustrated in FIG. 6, the electronic device may include a processor 610. The processor 610 may call and execute the computer programs in a memory to execute the method in the embodiments of the disclosure.

In at least one embodiment, as illustrated in FIG. 6, the communication device 600 may further include a memory 620. The processor 610 may call and execute the computer programs in the memory 620 to execute the method in the embodiments of the disclosure.

The memory 620 may be a separate device from the processor 610, or may be integrated into the processor 610.

In at least one embodiment, as illustrated in FIG. 6, the electronic device 600 may further include a transceiver 630. The processor 610 may control the transceiver 630 to communicate with another device. Specifically, the processor 610 may control the transceiver 630 to send information or data to another device, or receive information or data from another device.

The transceiver 630 may include a transmitter and a receiver. The transceiver 630 may further include one or more antennas.

The electronic device 600 may specifically be a network device in the embodiments of the disclosure. The electronic device 600 may implement a corresponding process implemented by the network device in each method embodiment of the disclosure, which will not be elaborated herein for brief description.

Alternatively, the communication device 600 may specifically be a terminal/mobile terminal in the embodiments of the disclosure. The communication device 600 may implement a corresponding process implemented by the terminal/mobile terminal in each method embodiment of the disclosure, which will not be elaborated herein for brief description.

FIG. 7 illustrates a block diagram of a chip according to an embodiment of the disclosure. As illustrated in FIG. 7, the chip 700 includes a processor 710. The processor 710 may call and execute the computer programs in a memory to execute the method in the embodiments of the disclosure.

In at least one embodiment, as illustrated in FIG. 7, the chip 700 may further include a memory 720. The processor 710 may call and execute the computer programs in the memory 720 to execute the method in the embodiments of the disclosure.

The memory 720 may be a separate device from the processor 710, and may also be integrated into the processor 710.

In at least one embodiment, the chip 700 may further include an input interface 730. The processor 710 may control the input interface 730 to communicate with another device or chip. Specifically, the processor 710 may control the input interface 730 to obtain information or data from another device or chip.

In at least one embodiment, the chip 700 may further include an output interface 740. The processor 710 may control the output interface 740 to communicate with another device or chip. Specifically, the processor 710 may control the output interface 740 to send information or data to another device or chip.

In at least one embodiment, the chip may be applied to the network device in the embodiments of the disclosure. The chip may implement a corresponding process implemented by the network device in each method embodiment of the disclosure, which will not be elaborated herein for brief description.

In at least one embodiment, the chip may be applied to the terminal/mobile terminal in the embodiments of the disclosure. The chip may implement a corresponding process implemented by the terminal/mobile terminal in each method embodiment of the disclosure, which will not be elaborated herein for brief description.

It is to be understood that in the embodiments of the disclosure, the chip may also be referred to as a system level chip, a system chip, a chip system or a system-on-chip.

It is to be understood that in the embodiments of the disclosure, the processor may be an integrated circuit chip with a signal processing capability. In an implementation process, each operation of the method embodiments may be completed by an integrated logical circuit of hardware in the processor or an instruction in a software form. The processor may be a universal processor, a Digital Signal Processor (DSP), an Application Specific Integrated Circuit (ASIC), a Field Programmable Gate Array (FPGA) or another programmable logical device, discrete gate or transistor logical device and discrete hardware component. Each method, step and logical block diagram disclosed in the embodiments of the disclosure may be implemented or executed. The universal processor may be a microprocessor or the processor may also be any related processor and the like. The operations of the methods disclosed in combination with the embodiments of the disclosure may be directly embodied to be executed and completed by a hardware decoding processor, or executed and completed by a combination of hardware and software modules in the decoding processor. The software module may be located in a mature storage medium in the art, such as a Random Access Memory (RAM), a flash memory, a Read-Only Memory (ROM), a Programmable ROM (PROM), an Electrically Erasable PROM (EEPROM) or a register. The storage medium is located in the memory. The processor reads information in the memory, and completes the operations of the above methods in combination with hardware of the processor.

It may be understood that the memory in the embodiment of the disclosure may be a volatile memory or a non-volatile memory, or may include the volatile memory and the non-volatile memory. The non-volatile memory may be an ROM, a PROM, an Erasable PROM (EPROM), an EEPROM or a flash memory. The volatile memory may be an RAM and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It is to be noted that the memory of the system and the method described in the disclosure is intended to include but not limited to memories of these and any other suitable type.

The embodiments of the disclosure also provide a non-transitory computer-readable storage medium for storing one or more computer programs.

In at least one embodiment, the non-transitory computer-readable storage medium may be applied in the network device of the embodiments of the disclosure. The computer programs may enable a processor to perform the corresponding process implemented by the network device in each method embodiment of the disclosure, which will not be elaborated herein for brief description.

In at least one example, the non-transitory computer-readable storage medium may be applied in the terminal/mobile terminal of the embodiments of the disclosure. The computer programs may enable a processor to perform the corresponding process implemented by the terminal/mobile terminal in each method embodiment of the disclosure, which will not be elaborated herein for brief description.

The embodiments of the disclosure also provide a computer program product. The computer program product includes one or more computer program instructions.

In at least one embodiment, the computer program product may be applied in the network device of the embodiments of the disclosure. The computer program instructions may enable a processor to perform the corresponding process implemented by the network device in each method embodiment of the disclosure, which will not be elaborated herein for brief description.

In at least one example, the computer program product may be applied in the terminal/mobile terminal of the embodiments of the disclosure. The computer program instructions may enable a processor to perform the corresponding process implemented by the terminal/mobile terminal in each method embodiment of the disclosure, which will not be elaborated herein for brief description.

The embodiments of the disclosure also provide a computer program.

In at least one embodiment, the computer program may be applied in the network device of the embodiments of the disclosure. The computer program, when executed by a processor, enables a processor to perform the corresponding process implemented by the network device in each method embodiment of the disclosure, which will not be elaborated herein for brief description.

In at least one example, the computer program may be applied in the terminal/mobile terminal of the embodiments of the disclosure. The computer program, when executed by a processor, enables a processor to perform the corresponding process implemented by the terminal/mobile terminal in each method embodiment of the disclosure, which will not be elaborated herein for brief description.

Those of ordinary skill in the art may realize that the units and algorithm operations of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that specific working processes of the system, device and unit described above may refer to the corresponding processes in the method embodiment and will not be elaborated herein for convenient and brief description.

In some embodiments provided by the disclosure, it is to be understood that the disclosed system, device and method may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

When being realized in form of software functional unit and sold or used as an independent product, the function may also be stored in a non-transitory computer-readable storage medium. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the operations of the method in each embodiment of the disclosure. The abovementioned storage medium includes: various media capable of storing program codes such as a U disk, a mobile hard disk, a ROM, a RAM, a magnetic disk or an optical disk.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A tensor processing method, comprising:
determining a first matrix based on a first tensor, wherein the first matrix comprises all elements of the first tensor; and
extracting a first sub-matrix from the first matrix, wherein the first sub-matrix comprises all elements of a first subtensor, and the first subtensor is a subset of the first tensor.

2. The method according to claim 1, wherein determining the first matrix based on the first tensor comprises:
performing a permutation operation on the first tensor having a first layout to obtain the first tensor having a second layout; and
determining the first matrix based on the first tensor having the second layout.

3. The method according to claim 2, wherein in a case that the first tensor is a four-dimensional tensor, the first tensor has a shape of N×C×H×W, wherein each of N, C, H, and W represents a respective one of four dimensions of the first tensor; and
wherein the first layout of the first tensor is NCHW, and the second layout of the first tensor is WHCN.

4. The method according to claim 3, wherein determining the first matrix based on the first tensor having the second layout comprises:
taking the first tensor having the layout of WHCN as the first matrix having a shape of W×HCN, wherein W represents a first dimension of the first matrix, and HCN represents a second dimension of the first matrix.

5. The method according to claim 3, wherein the first tensor is represented by F, the first subtensor is represented by Fs, and the first tensor and the first subtensor satisfy the following equation:
Fs=F[0:N−1,0:C−1, hs: he, ws: we],
wherein expression 0:N−1 represents coordinates of a first element to a last element to be extracted in dimension N respectively; expression 0:C−1 represents coordinates of a first element to a last element to be extracted in dimension C respectively; expression hs: he represents a first element to a last element to be extracted in dimension H respectively; and
expression ws: we represents a first element to a last element to be extracted in dimension W respectively.

6. The method according to claim 5, wherein extracting the first sub-matrix from the first matrix comprises:
extracting the first sub-matrix from the first matrix according to the following equation:
Fs*=F*[ws:we, hs×N×C: he×N×C]
wherein F* represents the first tensor F of second layout WHCN and is viewed as the first matrix having a shape of W×HCN, and Fs* represents the first subtensor Fs of second layout and is viewed as the first sub-matrix.

7. The method of claim 3, wherein the first tensor is a four-dimensional tensor directed to image data, and determining the first matrix based on the first tensor having the second layout comprises:
taking the first tensor having the layout of WHCN as the first matrix having a shape of W×HCN, wherein N represents a number of images in a batch, H represents a number of pixels in a vertical dimension, W represents to a number of pixels in a horizontal dimension, and C represents a number of channels.

8. The method of claim 2, wherein the permutation operation on the first tensor is performed in a central processing unit (CPU).

9. The method of claim 2, wherein determining the first matrix based on the first tensor further comprises:
transferring data for the first tensor having the second layout to a graphical processing unit (GPU).

10. The method of claim 9, wherein extracting the first sub-matrix from the first matrix comprises:
extracting the first sub-matrix from the first matrix using a linear algebra library based on a GPU platform.

11. An electronic device, comprising:
a memory storing a computer program; and
a processor, adapted to call and execute the computer program stored in the memory to:
determine a first matrix based on a first tensor, wherein the first matrix comprises all elements of the first tensor; and
extract a first sub-matrix from the first matrix, wherein the first sub-matrix comprises all elements of a first subtensor, and the first subtensor is a subset of the first tensor.

12. The electronic device of claim 11, wherein the processor is further adapted to call and execute the computer program stored in the memory to:
perform a permutation operation on the first tensor having a first layout to obtain the first tensor having a second layout; and
determine the first matrix based on the first tensor having the second layout.

13. The electronic device of claim 12, wherein in a case that the first tensor is a four-dimensional tensor, the first tensor has a shape of N×C×H×W, wherein each of N, C, H, and W represents a respective one of four dimensions of the first tensor; and
wherein the first layout of the first tensor refers to NCHW, and the second layout of the first tensor refers to WHCN.

14. The electronic device of claim 13, wherein the processor is further adapted to call and execute the computer program stored in the memory to:
take the first tensor having the layout of WHCN as the first matrix having a shape of W×HCN, wherein W represents a first dimension of the first matrix, and HCN represents a second dimension of the first matrix.

15. The electronic device of claim 13, wherein the first tensor is represented by F, the first subtensor is represented by Fs, and the first tensor and the first subtensor satisfy the following equation:
Fs=F[0:N−1,0:C−1, hs: he, ws: we],
wherein expression 0:N−1 represents coordinates of a first element to a last element to be extracted in dimension N respectively; expression 0:C−1 represents coordinates of a first element to a last element to be extracted in dimension C respectively; expression hs: he represents a first element to a last element to be extracted in dimension H respectively; and
expression ws: we represents a first element to a last element to be extracted in dimension W respectively.

16. The electronic device of claim 15, wherein the processor is further adapted to call and execute the computer program stored in the memory to:
extract the first sub-matrix from the first matrix according to the following equation:
Fs*=F*[ws:we, hs×N×C: he×N×C]
wherein F* represents the first tensor F of second layout WHCN and is viewed as the first matrix having a shape of W×HCN, and Fs* represents the first subtensor Fs of second layout and is viewed as the first sub-matrix.

17. The electronic device of claim 13, wherein the first tensor is a four-dimensional tensor directed to image data, and the processor is further adapted to call and execute the computer program stored in the memory to:
take the first tensor having the layout of WHCN as the first matrix having a shape of W×HCN, wherein N represents a number of images in a batch, H represents a number of pixels in a vertical dimension, W represents to a number of pixels in a horizontal dimension, and C represents a number of channels.

18. The electronic device of claim 12, wherein the permutation operation on the first tensor is performed in a central processing unit (CPU).

19. The electronic device of claim 12, wherein the processor is further adapted to call and execute the computer program stored in the memory to:
transfer data for the first tensor having the second layout to a graphical processing unit (GPU).

20. A non-transitory computer-readable storage medium having stored thereon a computer program that, when executed by a processor, causes the processor to execute the method according to claim 1.
